(19) United States
(12) Patent Application Publication
(10) Pub. No.: US 2004/0114790 A1
(43) Pub. Date: Jun. 17, 2004

(54) Projection conversion device and method and elapsed-time differential image preparation device and method

(76) Inventors: Keiji Yamamoto, Amagasaki-shi (JP); Akiko Baba, Amagasaki-shi (JP); Takeshi Johkoh, Nishinomiya-shi (JP); Shuji Yamamoto, Minoh-shi (JP); Hironobu Nakamura, Nishinomiya-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/466,891

(22) PCT Filed: Jan. 25, 2002
(86) PCT No.: PCT/JP02/00552

(30) Foreign Application Priority Data
Jan. 26, 2001 (JP) 2001-018015

(51) Int. Cl. G06K 9/00

(52) U.S. Cl. 382/131

(57) ABSTRACT

A projection conversion system for producing a 2-dimensional chest projection image from a 3-dimensional chest CT data set includes a temporal subtraction image production section 7 for producing a temporal subtraction image from a pair of 2-dimensional chest projection images which are produced by making transformation of temporally sequential two 3-dimensional chest CT data sets at a projection transformation calculation section 5, and an image display section 9 capable of displaying the temporal subtraction image.

### TECHNICAL FIELD

The present invention relates to a method and a system for projection transformation in producing a 2-dimensional chest image from a 3-dimensional chest CT data set, and to a method and a system for producing a temporal subtraction image from the 2-dimensional chest image obtained by the projection transformation, and storing and displaying the temporal subtraction image.

### BACKGROUND ART

Conventionally, various mass examinations have been carried out. There was often the case in the mass examinations that an image diagnosis such as a chest X-ray examination, a gastric X-ray examination and the like must be performed.

Especially, a lung cancer is increasing these days, so that in a medical treatment, early detection is indispensable. Therefore, image diagnoses are especially required in the mass examinations.

However, in a conventional image diagnosis which uses a chest radiograph (hereinafter referred to a simple chest radiograph) produced by irradiating an X-ray through a human body from an X-ray source, it has been pointed out that there are many oversights in detection of a lung cancer so that improvement has long been desired.

In order to improve sensitivity in mass examinations, a computer-aided diagnosis system has been developed. As one of the examples, an algorithm for a temporal subtraction method of a simple chest radiograph was developed.

One of the examples of the algorithm for the temporal subtraction method of the simple chest radiograph is described in laid-opened Japan Patent No. Hei 7-37074.

FIG. 9 shows an outline of a flow chart in the above mentioned Japan Patent. The conventional system comprises a step (S50, S60) for obtaining a first and a second digital chest image, a step S70 for making registration between said first and said second digital images by giving non-linear warping to one of said first and second digital images, a step S80 for making subtraction process between said non-linear warped image and another digital image, and a step S90 for outputting the subtraction image to a monitor or the like. The conventional system is designed to detect a temporal change between a pair of temporally sequential digital images, to thereby improve sensitivity of diagnosis by obtaining an enhanced subtraction image.

There have been a technique that prior to interpretation of a subtraction image, a bone region such as a rib or the like, which becomes an obstacle to interpretation, is eliminated from the chest CT data set, to then produce a projection image. An example of X-ray CT scanner is described in laid-opened Japan Patent No. Hei 7-51259. The conventional device comprises image recomposing means for recomposing an image corresponding to a simple chest radiograph which is produced based on a image data that is produced by extracting and eliminating a data of the bone region such as a rib or the like from a 3-dimensional data obtained by the X-ray CT scanner. The conventional device is designed to carry out interpretation and diagnosis efficiently by reducing the number of images to be interpreted.

However, in the above mentioned algorithm of the publicly known temporal subtraction method on the basis of the simple chest radiograph, there was such a problem that processing can only be carried out based on the 2-dimensional simple chest radiographs as original images.

Furthermore, the region, that should be diagnosed to be determined whether there is a lesion or not, is a lung field, but an unnecessary portion (bone region such as a rib or the like) other than the lung field is overlappingly projected to form a dark shadow in the simple chest radiograph, thereby deteriorating sensitivity of diagnosis in determining a lesion by an interpretation doctor.

On the other hand, the above mentioned prior art, in which a projection image is produced after eliminating a bone region such as a rib or the like from the chest CT data set, is a technique to simply produce a 2-dimensional projection image after eliminating the bone region from a 3-dimensional chest CT data set. Therefore, a temporal change of a patient was not able to be detected.

Therefore, an object of the present invention is to produce a 2-dimensional chest projection image from a 3-dimensional CT data set and to detect a temporal change of a patient by producing a clear 2-dimensional temporal subtraction image without a shadow of a bone region such as a rib etc. Another object of the present invention is to further improve work efficiency in interpretation of a radiograph.

### DISCLOSURE OF THE INVENTION

In order to solve the above mentioned objects, a first aspect of the present invention is a system for performing projection transformation to produce a 2-dimensional chest projection image, comprising:

an image data reading section for reading a 3-dimensional chest CT data set into an image data storage memory;

a projection line production section for producing a hypothetical projection line; and

a projection transformation calculation section for transforming said 3-dimensional chest CT data set into a 2-dimensional projection value by adding a hypothetical projection line to said 3-dimensional chest CT data set which is read in from the image data reading section.

According to the first aspect mentioned above, the 3-dimensional chest CT data set obtained from an X-ray CT scanner can be transformed into a 2-dimensional chest projection image, so that there is no more necessity of using the conventional simple chest radiograph. Therefore, image diagnosis of a chest lesion such as a lung cancer etc., can be easily performed by only using the 3-dimensional chest CT data set.

A second aspect of the present invention is a system, comprising:

a projection transformation system described in the first aspect;

a temporal subtraction image production section for producing a temporal subtraction image from a pair of said 2-dimensional chest projection images and writing the temporal subtraction image on said image data storage memory, the pair of said 2-dimensional chest projection images being produced from a temporally sequential pair of said 3-dimensional chest CT data set; and

an image display section capable of displaying said temporal subtraction image produced by the temporal subtraction image production section.

According to the second aspect mentioned above, since the temporal subtraction image between the pair of temporally sequential 2-dimensional chest projection images, which are produced from the pair of temporally sequential 3-dimensional chest CT data sets obtained from the X-ray CT scanner, can be confirmed by the image display section, a temporal change of a patient can be interpreted. In addition, the number of overcounting or oversight of a lesion during diagnosis can be reduced because an interpretation doctor can interpret the image together with the CT data sets.

Furthermore, in cases where conventional diagnosis is carried out by using the CT data sets, interpretation doctors must perform interpretation with at least dozens of images per patient. And in cases where the interpretation doctors study a temporal change, they must perform interpretation with 2 times as many images as in the conventional diagnosis. But in the present invention, interpretation doctors can interpret a temporal change by using only one temporal subtraction image according to the system of the present invention, improving work efficiency in interpretation and reducing the burden on the interpretation doctors. The present invention also contributes to increase in reliability of interpretation.

A third aspect of the present invention is a system according to the second aspect of the invention, further comprising:

a chest CT data set storage section for storing said 3-dimensional chest CT data set which is obtained from an X-ray CT scanner, the chest CT data set storage section being connected to said image data reading section; and

a temporal subtraction image storage section for storing said temporal subtraction image, the temporal subtraction image storage section being connected to said image data storage memory.

According to the third aspect mentioned above, chest CT data sets obtained from another X-ray CT scanner can be stored, and a necessary pair of temporally sequential 3-dimensional chest CT data sets are read out therefrom if necessary to produce a pair of chest projection image. A temporal subtraction image can be produced from the pair of chest projection images. Therefore, since a 3-dimensional chest CT data set to be used can be one obtained in the past or obtained from any unspecified X-ray CT scanners, the system of the present invention can be used as a general-purpose chest image diagnosis system.

A forth aspect of the present invention is a method for performing projection transformation, comprising:

setting a 3-dimensional chest CT data set between a hypothetical X-ray source and a projection plane;

integrating a CT value within a specific region of said 3-dimensional chest CT data set to produce a 2-dimensional projection value, a projection line being connected between said X-ray source and said projection plane and passed through the specific region; and

producing a 2-dimensional chest projection image from the 3-dimensional chest CT data set on the basis of the 2-dimensional projection value.

According to the fourth aspect mentioned above, since a 3-dimensional chest CT data set obtained from an X-ray CT scanner can be transformed into a 2-dimensional chest projection image, a simple chest radiograph is no more required, thereby being easily able to perform image diagnosis of a lesion in the chest such as a lung cancer etc., only on the basis of the 3-dimensional chest CT data set. Especially, since a 2-dimensional projection value obtained by integrating the CT value in the specific region of the 3-dimensional chest CT data set through which the projection lines pass is adopted, accurate 2-dimensional chest front projection image can be obtained even if there is an inclination of the hypothetical body when, for example, a chest front projection image is required to be produced.

A fifth aspect of the present invention is a method for producing a temporal subtraction image of a 2-dimensional chest image by using the temporal subtraction image production system of the 2-dimensional chest image according to the second or the third aspect of the present invention, comprising:

producing two 2-dimensional chest projection images from a temporally sequential pair of 3-dimensional chest CT data sets respectively by using the projection transformation method according to the fourth aspect of the present invention, the two 2-dimensional chest projection images being used as original images for producing a temporal subtraction image; and

performing registration between said pair of 2-dimensional chest projection images on the basis of a registration data produced from said two 2-dimensional chest projection images.

According to the fifth aspect mentioned above, the temporal change of a patient can be interpreted from only one sheet of the temporal subtraction image, thereby being able to minimize the burden imposed on the interpretation doctors when they perform interpretation.

A sixth aspect of the present invention is a method for producing a temporal subtraction image by using the temporal subtraction image production system of 2-dimensional chest image according to claim 2 or 3, comprising:

producing two temporally sequential pair of 3-dimensional bone region-eliminated CT data sets from a temporally sequential pair of 3-dimensional chest CT data sets by eliminating a bone region such as a rib or the like;

producing two 2-dimensional bone region-eliminated projection images from said pair of 3-dimensional bone region-eliminated CT data sets by using the projection transformation method according to claim 4, the two 2-dimensional bone region-eliminated projection images being used as original images for producing a temporal subtraction image; and

performing registration between said two 2-dimensional bone region-eliminated projection images on the basis of a registration data produced from two 2-dimensional chest projection images, the two 2-dimensional chest projection images being produced from said two 3-dimensional chest CT data sets by projection transformation.

According to the sixth aspect mentioned above, as the bone region such as a rib or the like is completely eliminated from the temporal subtraction image, only a lesion portion is displayed clearly, being able to considerably minimize the burden imposed on the interpretation doctors and improving work efficiency markedly when interpretation is performed.

### BRIEF DESCRIPTION OF THE DRAWINGS

FIG. 1 is a block diagram of a scheme of a temporal subtraction image production system of a 2-dimensional chest image according to an embodiment of the present invention.

FIG. 2 is a schematic diagram of a first method for producing the temporal subtraction image by using the temporal subtraction image production system according to the present invention.

FIG. 3 is a schematic diagram of a second method for producing the temporal subtraction image by using the temporal subtraction image production system according to the present invention.

FIG. 4 is a flow chart of a practical method of projection transformation process.

FIG. 5a is a conceptual diagram of a method to produce a 2-dimensional chest projection image based on a hypothetical X-ray source and a central projection.

FIG. 5b is a conceptual diagram of a method to produce a 2-dimensional chest projection image based on the hypothetical X-ray source and a parallel projection.

FIG. 6 is a flow chart of a practical method of registration data production.

FIG. 7 is a flow chart of a practical method of bone region-eliminated CT data set production.

FIG. 8 is a flow chart of a practical method of a temporal subtraction image production.

FIG. 9 is a flow chart of an outline of a conventional temporal subtraction method using a simple chest radiograph according to related art.

### PREFERRED EMBODIMENT FOR CARRYING OUT THE INVENTION

The present invention will be described hereunder by referring to the accompanying drawings.

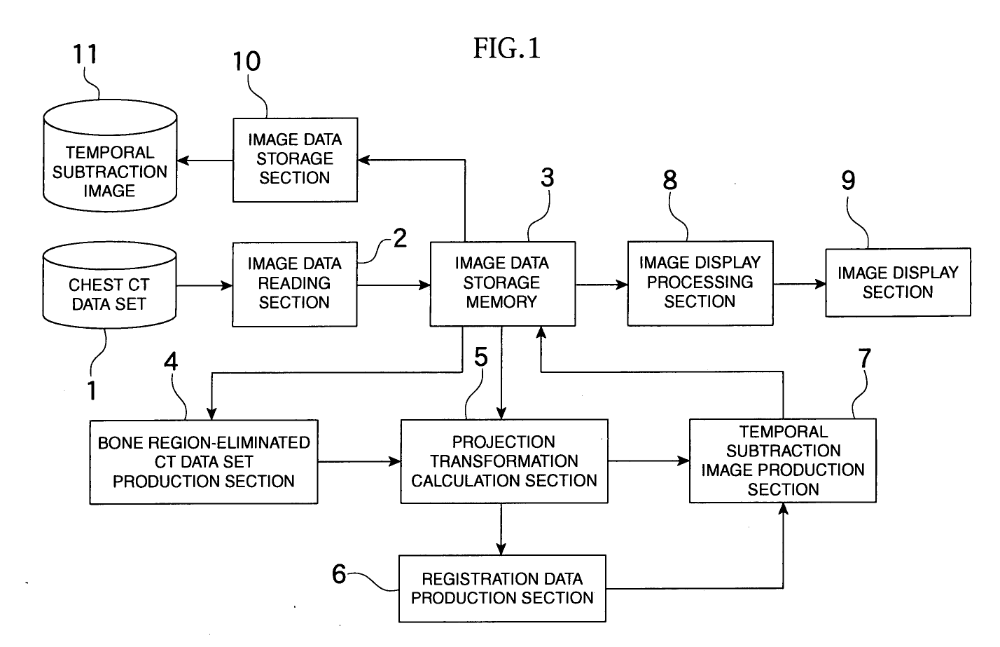

FIG. 1 is a block diagram of a scheme of a temporal subtraction image production system of a 2-dimensional chest image according to the present invention.

In FIG. 1, a chest CT data set 1 is an unprocessed 3-dimensional chest CT data set obtained from an X-ray CT scanner and is stored in the form of file format or data base. An image data reading section 2 is a section for reading the chest CT data set 1 based on a prescribed demand and storing it on an image data storage memory 3. A bone region-eliminated CT data set production section 4 is a section for conducting derivation of a binary image corresponding to a bone region such as a rib etc., based on the chest CT data set 1 input from the image data storage memory 3, and then producing a bone region-eliminated CT data set by replacing a pixel corresponding to the bone region such as a rib etc., with an alternative CT value.

A projection transformation calculation section 5 is a section for producing a 2-dimensional projection image by performing projection transformation with the use of a hypothetical X-ray source on the basis of the bone region-eliminated CT data set in the bone region-eliminated CT data set production section or on the basis of the chest CT data set 1 in the image data storage memory 3. Various conditions relating to the hypothetical X-ray source and a projection plane are required for performing projection transformation. These conditions are specified so as to be able to obtain a chest front image as the projection image. In addition, the projection image transformation calculation section 5 includes a projection line production section (not shown in FIG. 1) for producing a hypothetical projection line and a projection image production section (not shown in FIG. 1) which adds the hypothetical projection line produced at the projection line production section to the chest CT data set 1 stored in the image data storage memory 3, then produces 2-dimensional projection value to obtain the projection image projected on the hypothetical projection plane, and finally produces the 2-dimensional projection image on the basis of the projection value.

A registration data production section 6 is a section for producing a registration data to perform registration pixel by pixel between the two projection images produced at the projection transformation calculation section 5 on the basis of a temporally sequential pair of chest CT data sets that are taken at different study time for the same patient, and then sending the registration data to a temporal subtraction image production section 7.

The temporal subtraction image production section 7 is a section for producing a subtraction image (2-dimensional) between the two projection images produced at the projection transformation calculation section 5 with the use of the registration data produced at the registration data production section 6, and then sending the subtraction image to the image data storage memory 3. In this instance, the 2-dimensional projection images produced by performing projection transformation of the chest CT data sets or 2-dimensional projection images produced by performing projection transformation of the bone region-eliminated CT data sets are used as a temporally sequential pair of projection images.

An image display processing section 8 is a section for displaying the 3-dimensional chest CT data set stored in the image data storage memory 3 or the 2-dimensional temporal subtraction image produced at the temporal subtraction image production section 7, based on a prescribed demand.

An image display section 9 has a display unit such as a CRT, a plasma display, a liquid crystal display etc. In the temporal subtraction image production system of the present invention, a high resolution CRT having more than 1000 scanning lines is desirable, because the system is used for a medical system.

An image data storage section 10 is a section for taking out the temporal subtraction image produced at the temporal subtraction image production section 7 from the image data storage memory 3, and storing it in the form of file format or data base etc., based on a prescribed demand.

The temporal subtraction image data 11 is a data of a temporal subtraction image which is to become a final output image from the temporal subtraction image production system of the present invention and is stored in the form of file format or data base etc.

Hereinafter, methods to produce a 2-dimensional chest projection image and to produce a temporal subtraction image from the chest projection images will be explained.

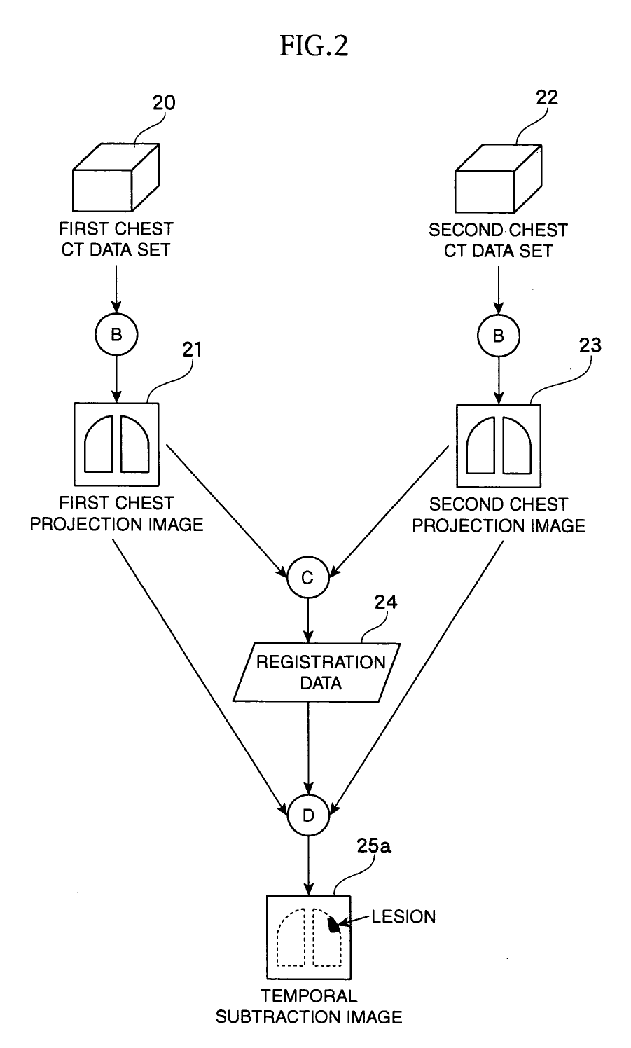

FIG. 2 is a schematic diagram of a first embodiment for producing a temporal subtraction image by using the temporal subtraction image production system of the present invention.

At first, a first 3-dimensional chest CT data set 20 is processed at a projection transformation process (step B) to produce a first 2-dimensional chest projection image 21. Similarly, a second 3-dimensional chest CT data set 22 is processed at a projection transformation process (step B) to produce a second 2-dimensional chest projection image 23.

Next, a feature data such as a lung contour etc., is extracted from both of the first chest projection image 21 and the second chest projection image 23 and then a registration data 24 between the first chest projection image 21 and the second chest projection image 23 is produced by using these feature data (step C).

Then, a 2-dimensional temporal subtraction image 25a between the first chest projection image 21 and the second chest projection image 23 is produced on the basis of the thus obtained registration data 24 (step D).

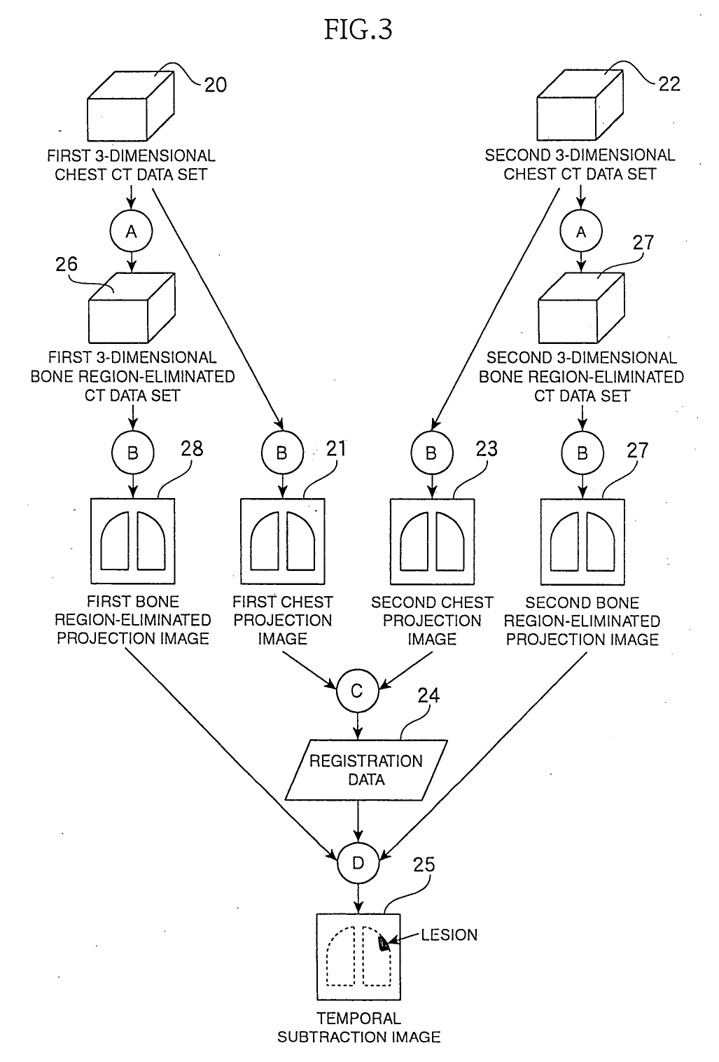

FIG. 3 is a schematic diagram of a second embodiment for producing a temporal subtraction image with the use of the temporal subtraction image production system of the present invention.

In the second embodiment, a registration data 24, which is required for producing a temporal subtraction image, is produced, like the first embodiment, on the basis of the first chest 2-dimensional projection image 21 and the second chest 2-dimensional projection image 23 both of which are produced from the first and the second 3-dimensional chest CT data set 20, 22, respectively.

In the steps of the second embodiment, at first a bone region such as a rib etc. is extracted from the first 3-dimensional chest CT data set 20 and then the bone region such as a rib etc. is eliminated to produce a first 3-dimensional bone region-eliminated CT data set 26 (step A). Similarly, a bone region such as a rib etc. is extracted from the second 3-dimensional chest CT data set 22 and then the bone region is eliminated therefrom to produce a second 3-dimensional bone region-eliminated CT data set 27 (step A).

Next, the first 3-dimensional bone region-eliminated CT data set 26 is processed at a projection transformation process (step B) to produce a first 2-dimensional bone region-eliminated projection image 28. Similarly, the second 3-dimensional bone region-eliminated CT data set 27 is processed at the projection transformation process (step B) to produce a second 2-dimensional bone region-eliminated projection image 29.

Next, a 2-dimensional temporal subtraction image 25b between the first and the second bone region-eliminated projection images 28, 29, is produced by using the first and the second bone region-eliminated projection images 28, 29, and a registration data 24 (step D).

Accordingly, in the second embodiment, the temporal subtraction image 25b, which is the final output image obtained at step D, is produced from the bone region-eliminated projection images as original images, which are produced from the bone region-eliminated CT data sets. The difference between the first and second embodiment resides in this point.

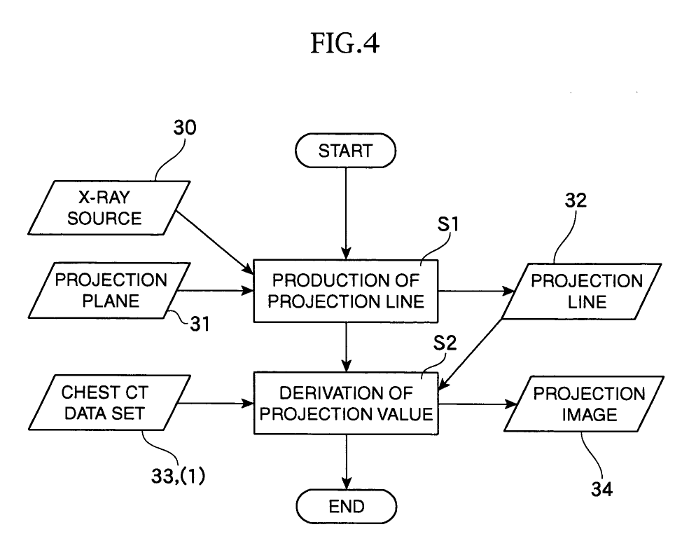

Next, a practical method of the projection transformation process in step B will be explained by referring to the flow chart shown in FIG. 4.

In FIG. 4, a projection line 32, which connects between a position of each pixel of a projection image in a projection plane 31 and a position of an X-ray source 30, is produced on the basis of the X-ray source 30 and the projection plane 31 those of which are given as input conditions (step S1).

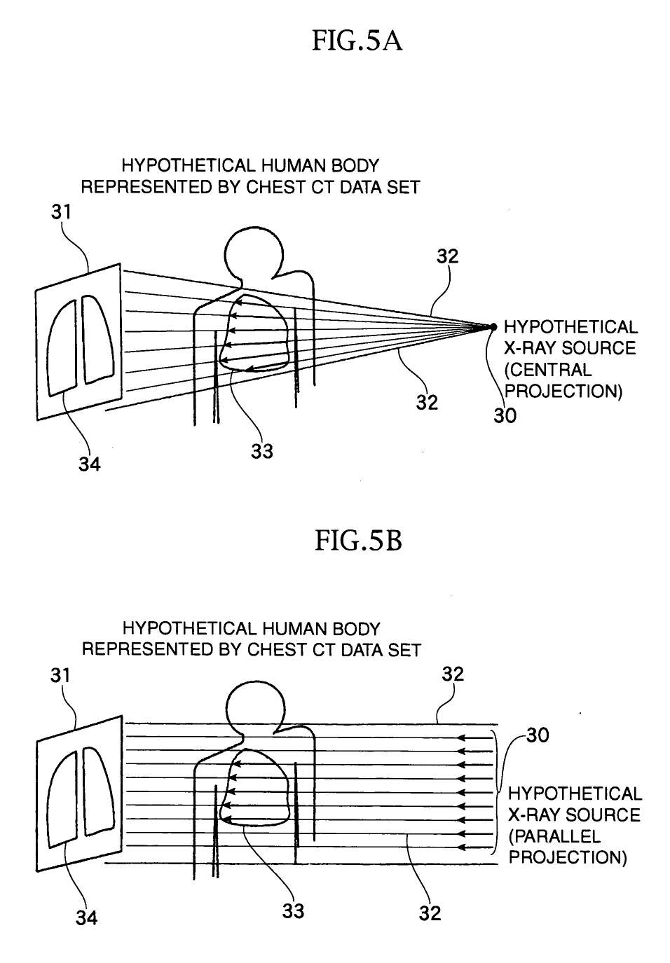

The condition of irradiation of the hypothetical X-ray is determined by the X-ray source 30. More specifically, the X-ray source 30 has factors relating to a projection method of, for example, a central projection shown in FIG. 5a or a parallel projection shown in FIG. 5b, a voltage of an X-ray tube, a vector of a projection direction etc. The projection plane 31 has a condition to prescribe a location of the projection image 34 in the 3-dimensional space. More specifically, the projection plane specifies a spatial position of the 3-dimensional plane, a position of the projection image 34 on the 3-dimensional plane, a size of the pixel, resolution etc. And in order to apply the temporal subtraction method, specific conditions of the X-ray source 30 and the projection plane 31 are given for producing a chest front image.

Same conditions for the X-ray source 30 and the projection plane 31 are commonly used in the first and the second embodiment. In the first embodiment, the 2-dimensional chest projection images 21, 23 produced from the 3-dimensional chest CT data sets 20, 22 are used as original images, and in the second embodiment, the bone region-eliminated projection images 28, 29 produced from the bone region-eliminated CT data sets 26, 27 are used as original images.

Derivation of the projection value is conducted as a result of irradiation to the hypothetical 3-dimensional chest CT data set 33 by a plurality of the projection lines 32 the number of which corresponds to that of pixel produced in step S1 (step S2), to thereby output the projection image 34. The projection value is a value obtained by integrating CT values on whole specific region (chest region) of the hypothetical 3-dimensional chest CT data set 33 through which the projection line 32 passes. In other words, even when there is, for example, an inclination of a hypothetical human body (3-dimensional chest CT data set 33), an accurate 2-dimensional chest front projection image can be obtained, because the 2-dimensional projection value, which is obtained by integration of CT values on the specific region in the 3-dimensional chest CT data set the region of which the projection lines pass through, is used as the projection value. The projection value, which is obtained by the projection transformation process, is confirmed to be an approximately same value of a projection value in the simple chest radiograph.

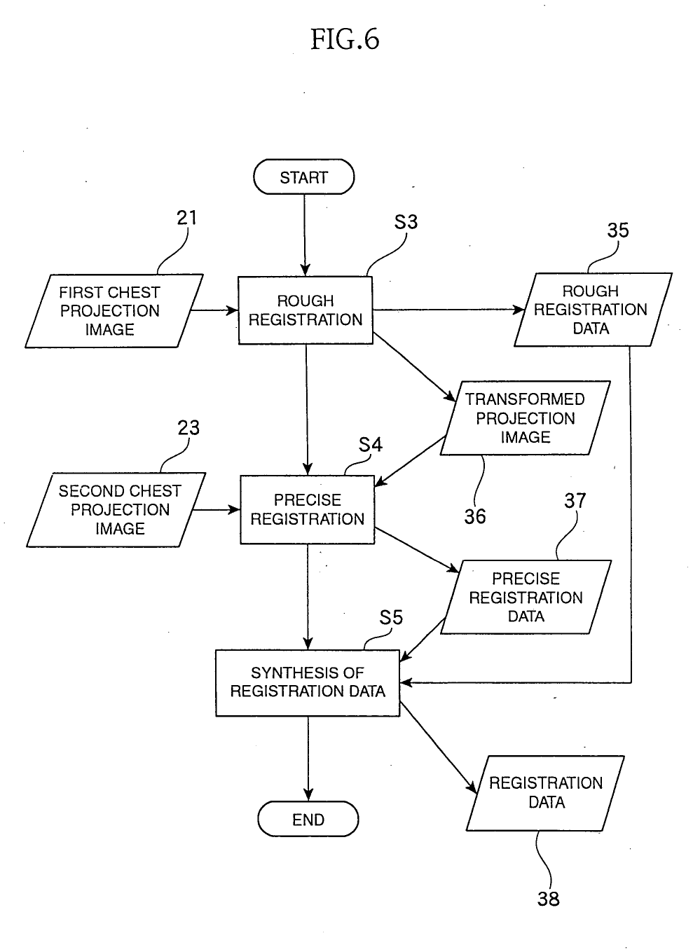

Next, a practical process for producing the registration data in step C will be explained by referring to the flow chart shown in FIG. 6.

In step C of FIG. 2 or FIG. 3, the registration data 24, which is used for registration of misalignment, pixel by pixel, between the temporally sequential first and second chest projection images 21, 23. The process includes following steps, that is, a rough registration step which is carried out based on the whole image between the first chest projection image 21 and the second chest projection image 23 (step S3), a precise registration step which is carried out pixel by pixel between the transformed projection image 36 and the second chest projection image 23 (step S4), and a synthesis step to synthesize the registration data 35 obtained by the rough registration S3 and the precise registration data 37 obtained by the precise registration S4 (step S5).

As a result of rough registration S3, an affine transformation matrix for the whole image area is obtained as the rough registration data 35. The affine transformation matrix is applied to the first chest projection image 21 to produce the transformed projection image 36.

Derivation of the position of the pixel before transformation, which corresponds to the position of the pixel after transformation, is conducted by coordinate transformation by using affine transformation matrix and derivation of the pixel value is conducted for each pixel value of the original projection image and then the produced pixel value is stored in each corresponding pixel of the transformed projection image 36.

The rough registration S3 is practically performed by pattern matching between images based on an area ⅓ times the size of the projection images by using a feature data represented by a lung contour.

The precise registration step is performed pixel by pixel between the transformed projection image 36 produced in the rough registration S3 and the second chest projection image 23 (step S4). As a result of the precise registration S4, a different shift vector is obtained in each of the pixels as the precise registration data 37. The shift vector is a vector representing a coordinate move of the pixel and is used for registration between the second chest projection image 23 and the transformed projection image 36 by further performing transformation of the transformed projection image 36. In the precise registration S4, derivation of the shift vector is conducted for each pixel respectively so as to correct slight misalignment.

In the precise registration S4, the original image is practically divided into a small image area having a side dimension 1/10 times the length of the original image, and then the pattern matching is performed to produce a registration data between a pair of image areas. By interpolating the thus obtained registration data, the shift vector is produced for each pixel.

The rough registration data 35 produced by the rough registration S3 and the precise registration data 37 produced by the precise registration S4 are synthesized (step S5), to produce a final registration data 38. The final registration data 38 has a different shift vector for each pixel.

In addition, when the temporal subtraction image is displayed on the image display section 9, a temporally older image, which is the first projection image 21, is to be adopted as an image to be transformed in the rough registration S3, since comparative interpretation is usually performed by comparing with an untransformed temporally newer image. Either of the pair of temporally sequential images can be transformed. In other words, only the second projection image 23, which is a temporally newer image, may be transformed.

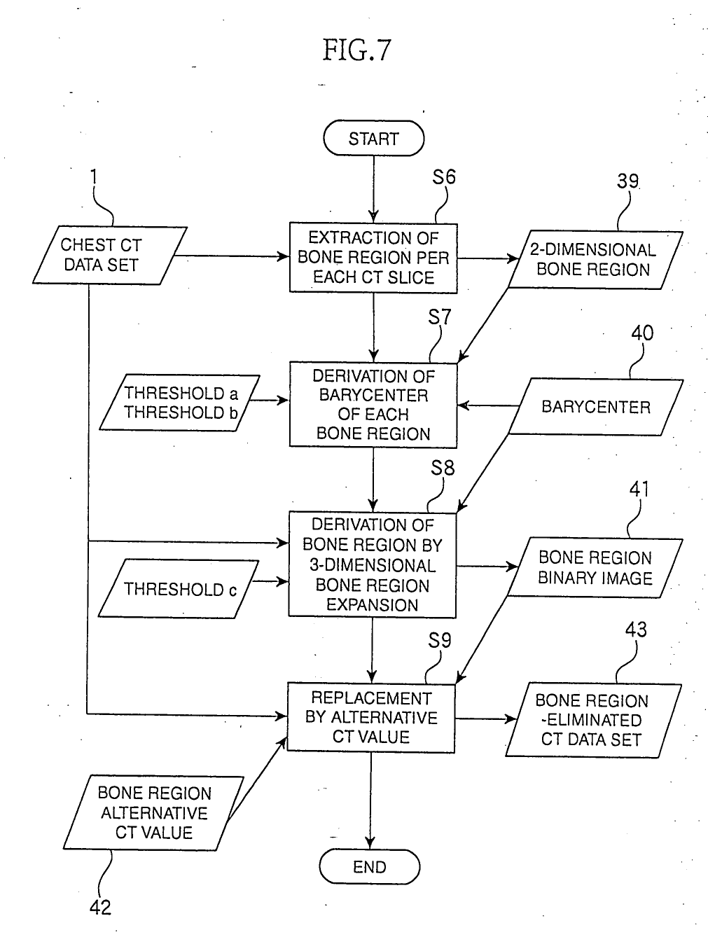

Next, a practical method for producing the bone region-eliminated CT data set in step A will be explained by referring to the flow chart shown in FIG. 7.

In step A in FIG. 3, a bone region-eliminated CT data set 43 is produced by eliminating a bone region such as a rib etc., from a chest CT data set 1. The precise procedure is that at first thresholding is performed for each CT slice of the chest CT data set 1 to extract a 2-dimensional bone region 39 (step S6). According to this step, a binary image of the bone region can be produced for each CT slice.

Thresholding is practically carried out by two steps. First, a binary image is produced under the condition that among CT values taken out of the CT slice, pixel having a value larger than threshold a is set to 1, and other pixel is set to 0. Next, among island regions in the binary image, pixel that belongs to region area larger than threshold b is set to 1, and other pixel is set to 0. In this instance, the threshold a is set to a pixel value (for example 250 HU) corresponding to a cortical portion of the bone region. The threshold b is used for eliminating the island region which is extracted due to noise in the CT data set and may also be set to an appropriate value (for example 100 pixel).

Then, derivation of a barycenter position 40 of each island region is conducted with respect to the binary image that represents the 2-dimensional bone region 39 that is obtained in step S6 (step S7).

Next, derivation of a 3-dimensional bone region binary image 41, which represents the bone region, is conducted by applying the 3-dimensional region expansion process starting from each barycenter position 40 to the chest CT data set 1 as a 3-dimensional image (step S8). Practical process of the 3-dimensional region expansion is performed by threading out pixels one by one from the starting point within the CT data set to produce the 3-dimensional binary image under the condition that the value is set to 1 when a CT value of an adjacent pixel is larger than a threshold C (for example 100 HU) and is set to 0 when the CT value is smaller than that. The 3-dimensional region expansion is carried out for each barycenter respectively and the thus obtained pixel region is ORed to give the final bone region 41.

With respect to the pixel corresponding to the bone region produced in step S8, the pixel value of the CT data set is replaced by a bone region alternative CT value 42 (step S9), to output a bone region-eliminated CT data set 43. The bone region alternative CT value 42 is set on the basis of a knowledge data base of medical field so as to reduce an influence of the bone region on the 2-dimensional projection image obtained, through projection transformation, from the bone region-eliminated CT data set 43. For example, an average CT value (−400 HU) in the lung field region can be preferably used.

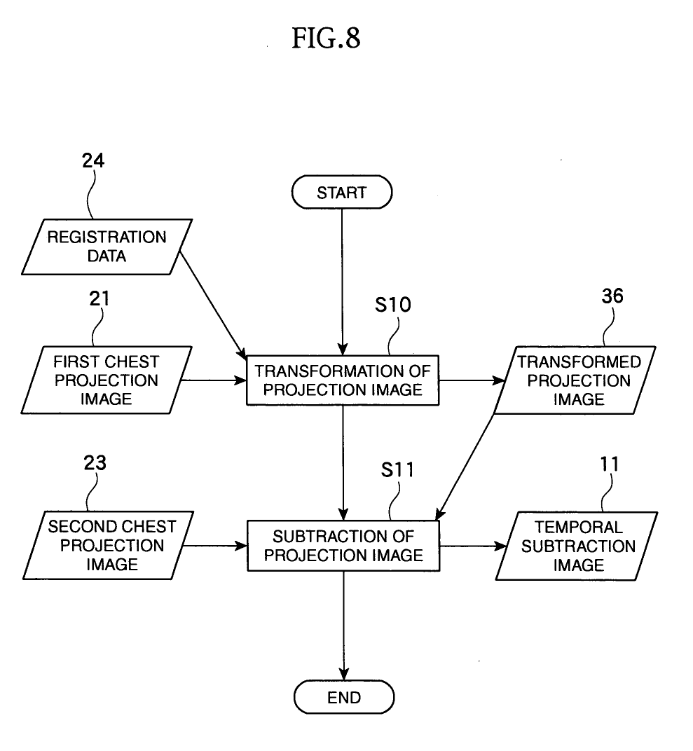

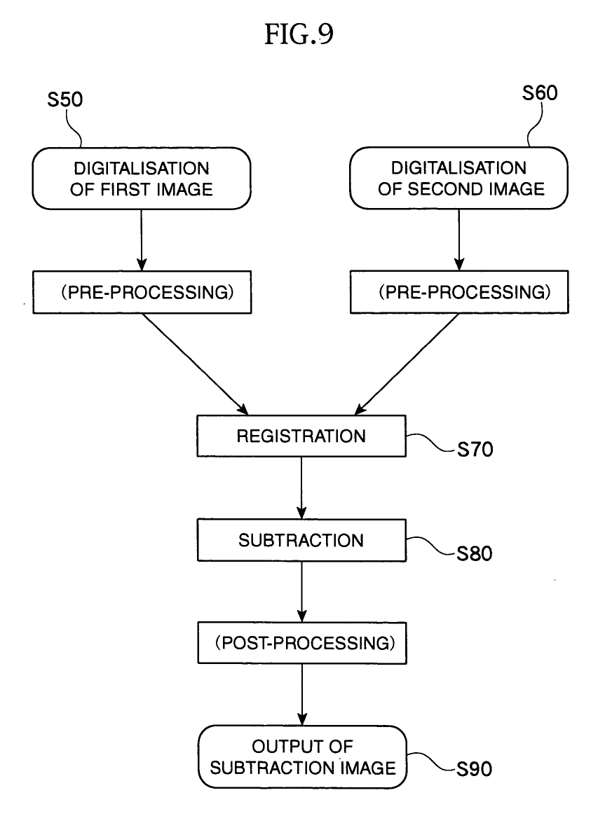

Next, a practical process for producing a temporal subtraction image in step D will be explained by referring to the flow chart shown in FIG. 8.

In step D in FIG. 2 or FIG. 3, the registration data 24 obtained by producing a registration data is applied to the first chest projection image 21 or the first bone region-eliminated projection image 28 to transform them (step S10) into the transformed projection image 36. In addition, when the temporal subtraction image is displayed on the image display section 9, a temporally older image, which is the first chest projection image 21 or the first bone region-eliminated projection image 28, is often used as an image to be transformed since comparative interpretation is usually performed by comparing with an untransformed temporally newer image. Either of a pair of temporally sequential images can be transformed. Namely, a temporally newer image of the second chest projection image 23 or the second bone region-eliminated projection image 29 can be transformed.

Next, the subtraction image is produced from a pair of the transformed projection image 36 produced at the step S10 and the second chest projection image 23 or the second bone region-eliminated projection image 29 (step S11), to then output the temporal subtraction image 11.

Like the second method mentioned above, in cases where the temporal subtraction image is produced from a chest image from which bone regions such as ribs etc. are eliminated in advance, the temporal subtraction image has no shadow of the bone region because no bone region exists from the beginning.

In other words, when a temporal subtraction image is produced on the basis of simple chest radiographs from which the bone region is not eliminated, the bone region could be ideally cancelled out to produce the temporal subtraction image with no shadows of bones. But a perfect registration data can hardly be obtained so that small amount of shadow of bone regions actually remains, because the subtraction is carried out by using images taken at different study time. On the contrary in the temporal subtraction image production device for a 2-dimensional chest image of the present invention, a lesion portion can be clearly shown because bone regions such as a rib etc., are completely eliminated even though the registration data is somewhat incomplete. Therefore, interpretation can be carried out efficiently with small burden on interpreters.

### Industrial Applicability

The present invention is industrially useful and can be applied to an image diagnosis in a mass examination such as a chest X-ray examination, a gastric X-ray examination etc. and realized as an image display device capable of displaying two temporal subtraction images and carrying out interpretation of a temporal change of a patient accurately.

What is claimed:

1. A system for performing projection transformation to produce a 2-dimensional chest projection image, comprising:
an image data reading section for reading a 3-dimensional chest CT data set into an image data storage memory;
a projection line production section for producing a hypothetical projection line; and
a projection transformation calculation section for transforming said 3-dimensional chest CT data set into a 2-dimensional projection value by adding the hypothetical projection line to said 3-dimensional chest CT data set which is read in from the image data reading section.

2. A system for producing a temporal subtraction image of a 2-dimensional chest image, comprising:
a projection transformation system described in claim 1;
a temporal subtraction image production section for producing a temporal subtraction image from a pair of said 2-dimensional chest projection images and writing the temporal subtraction image on said image data storage memory, the pair of said 2-dimensional chest projection images being produced from a temporally sequential pair of said 3-dimensional chest CT data set; and
an image display section capable of displaying said temporal subtraction image produced by the temporal subtraction image production section.

3. A system for producing a temporal subtraction image of a 2-dimensional chest image according to claim 2, further comprising:
a chest CT data set storage section for storing said 3-dimensional chest CT data set which is obtained from an X-ray CT scanner, the chest CT data set storage section being connected to said image data reading section; and
a temporal subtraction image storing section for storing said temporal subtraction image, the temporal subtraction image storing section being connected to said image data storage memory.

4. A method for performing projection transformation, comprising:
setting a 3-dimensional chest CT data set between a hypothetical X-ray source and a projection plane;
integrating a CT value within a specific region of said 3-dimensional chest CT data set to produce a 2-dimensional projection value, a projection line being connected between said X-ray source and said projection plane and passed through the specific region; and
producing a 2-dimensional chest projection image from the 3-dimensional chest CT data set on the basis of the 2-dimensional projection value.

5. A method for producing a temporal subtraction image of a 2-dimensional chest image by using the temporal subtraction image production system of the 2-dimensional chest image according to claim 2 or 3, comprising:
producing two 2-dimensional chest projection images from a temporally sequential two 3-dimensional chest CT data sets by using the projection transformation method according to claim 4, the two dimensional chest projection images being used as original images for producing a temporal subtraction image; and
performing registration between said two 2-dimensional chest projection images on the basis of a registration data produced from said two 2-dimensional chest projection images.

6. A method for producing a temporal subtraction image by using the temporal subtraction image production system of a 2-dimensional chest image according to claim 2 or 3, comprising:
producing two temporally sequential 3-dimensional bone region-eliminated CT data sets from two temporally sequential 3-dimensional chest CT data sets by eliminating a bone region such as a rib or the like;
producing two 2-dimensional bone region-eliminated projection images from said two 3-dimensional bone region-eliminated CT data sets by using the projection transformation method according to claim 4, the two 2-dimensional bone region-eliminated projection images being used as original images for producing a temporal subtraction image; and
performing registration between said two 2-dimensional bone region-eliminated projection images on the basis of a registration data produced from two 2-dimensional chest projection images, the two 2-dimensional chest projection images being produced from said two 3-dimensional chest CT data sets by projection transformation.
